(19) United States
(12) Patent Application Publication
(10) Pub. No.: US 2012/0007496 A1
(43) Pub. Date: Jan. 12, 2012

(54) ORGANIC ELECTROLUMINESCENCE LIGHTING APPARATUS

(75) Inventors: Satoshi MARUYAMA, Ishikawa-ken (JP); Takahiro OONUMA, Ishikawa-ken (JP)

(73) Assignee: Toshiba Mobile Display Co., Ltd., Fukaya-shi (JP)

(21) Appl. No.: 13/167,416

(22) Filed: Jun. 23, 2011

(30) Foreign Application Priority Data
Jul. 9, 2010 (JP) 2010-157265

(51) Int. Cl. H01J 1/62

(52) U.S. Cl. 313/504

(57) ABSTRACT

In one embodiment, an organic EL lighting apparatus includes a pixel line, a cathode line extending in substantially parallel each other in an active area, and a plurality of light emitting pixels. The light emitting pixel includes an anode electrode electrically connected to the pixel line, a cathode electrode arranged on the anode electrode and a light emitting organic layer arranged between the anode electrode and the cathode electrode. A dot is arranged adjacent to the light emitting pixel for a contact of the cathode line with the cathode electrode.

### CROSS-REFERENCE TO RELATED APPLICATION

This application is based upon and claims the benefit of priority from Japanese Patent Application No. 2010-157265, filed Jul. 9, 2010, the entire contents of which are incorporated herein by reference.

### FIELD

Embodiments described herein relate generally to an organic electroluminescence (hereafter, electroluminescence will be referred to as EL) lighting apparatus using organic light emitting elements.

### BACKGROUND

In recent years, concern is increasing to the global warming problem. In order to reduce the carbon dioxide emissions and to reduce a global warming, various energy savings are groped. Among them, an effective use of energy for a light is considered as one of important points. A filament lamp and fluorescent lamp which are used widely now are saturated from a point of luminous efficacy, and also research and development of the lighting apparatuses are done briskly to achieve a higher luminous efficacy.

Currently, the luminous efficacy and the life of the filament lamp are respectively about 15 lm/W and about 1,000 to 2,000 hours. Further, the luminous efficacy and the life of the fluorescent lamp are respectively about 50 to 100 lm/W and the life of about 10,000 hours. On the contrast, in the lighting apparatuses using organic EL elements, it is expected to exceed the above values of the filament lamp and the fluorescent lamp. Accordingly, it is thought that the organic EL lighting apparatuses can become an earth-friendly lighting.

On the other hand, although an LED lighting apparatus using a light emitting diode (light emitting diode: LED) which is expected as a next-generation lighting apparatus and to which development is advanced, an unevenness of luminescence intensity is reduced by arranging a plurality of LEDs in a high density. However, there is a limit in a high-density arrangement. Moreover, since it is necessary to mount a plurality of LEDs to make a light source with a large area, the assembly cost is raised. Therefore, the LED lighting apparatus has the problem that the manufacture of the field luminescence with a large area is still difficult.

The organic EL lighting apparatus has an advantage that a plurality of organic EL elements can be easily formed on the same substrate with respect to the above-mentioned problem. Therefore, the cost for mounting the light emitting elements can be reduced compared with the LED lighting apparatus mentioned-above, and it is thought that the organic EL lighting apparatus results in a low manufacturing cost.

By the way, in the organic EL equipments using a plurality of organic EL elements, such as the organic EL lighting apparatus and an organic EL display, a variation in performance occurs inevitably among the respective organic EL elements, and there is a possibility that the variation in the luminescence and an uneven coloring resulting from the variation of the luminescence luminosity may be generated. For example, many methods are proposed for adjusting a color balance shifted at the time of manufacturing.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view schematically showing a structure of an organic EL lighting apparatus according to an embodiment.

FIG. 2 is a top surface view showing an example of the structure of a pixel in a panel shown in FIG. 1.

FIG. 3 is a cross-sectional view showing the structure of a pixel taken along line A-B in FIG. 2.

FIG. 4 is a figure for explaining a technique for achieving a uniform characteristics of each light emitting pixel.

FIG. 5 is a figure for explaining another technique for achieving the uniform characteristics of each light emitting pixel.

### DETAILED DESCRIPTION OF THE INVENTION

An organic EL lighting apparatus according to an exemplary embodiment of the present invention will now be described with reference to the accompanying drawings wherein the same or like reference numerals designate the same or corresponding portions throughout the several views.

According to one embodiment, an organic EL lighting apparatus includes: a pixel line and a cathode line extending in substantially parallel each other in an active area; a light emitting pixel including an anode electrode electrically connected to the pixel line, a cathode electrode arranged on the anode electrode and a light emitting organic layer arranged between the anode electrode and the cathode electrode; and a dot arranged adjacent to the light emitting pixel for a contact of the cathode line with the cathode electrode.

According to other embodiment, an organic EL lighting apparatus includes: a first electric power supply pad and a second electric power supply pad; a first bus line electrically connected with the first electric power supply pad; a second bus line electrically connected with the second electric power supply pad; a first pixel line electrically connected with the first bus line; a second pixel line electrically connected with the second bus line; a first light emitting pixel including a first anode electrode connected with the first pixel line, a cathode electrode arranged on the first anode electrode, and a first light emitting organic layer for emitting a first color arranged between the first anode electrode and the cathode electrode; and a second light emitting pixel including a second anode electrode connected with the second pixel line, a cathode electrode arranged on the second anode electrode and a second light emitting organic layer for emitting a second color arranged between the second anode electrode and the cathode electrode; wherein the respective line resistance of the first bus line and the first pixel line, and the respective line resistances of the second bus line and the second pixel line are set so that a voltage drop in the first light emitting pixel becomes substantially the same as that of the second light emitting pixel.

According to other embodiment an organic EL lighting apparatus includes: a first electric power supply pad and a second electric power supply pad; a first bus line electrically connected with the first electric power supply pad; a second bus line electrically connected with the second electric power supply pad; a first pixel line electrically connected with the first bus line; a second pixel line electrically connected with the second bus line; a first light emitting pixel including a first anode electrode connected with the first pixel line, and a second light emitting pixel including a second anode electrode connected with the second pixel line; wherein a total load of the first bus line and the first pixel line in the first power supply pad is substantially the same as that of the second bus line and the second pixel line in the second power supply pad.

According to other embodiment, an organic EL lighting apparatus includes: a first electric power supply pad and a second electric power supply pad; a first bus line and a second bus line; a second bus line electrically connected; a first connecting line for electrically connecting the first electric power supply pad with the first bus line; a second connecting line for electrically connecting the second electric power supply pad with the second bus line; a first pixel line electrically connected with the first bus line; a second pixel line electrically connected with the second bus line; a first emitting pixel including a first anode electrode connected with the first pixel line, and a second emitting pixel including a second anode electrode connected with the second pixel line; wherein the respective line resistances of the first connecting line and the second connecting line are set so that a voltage drop of the first connecting line becomes substantially the same as that of the second connecting line.

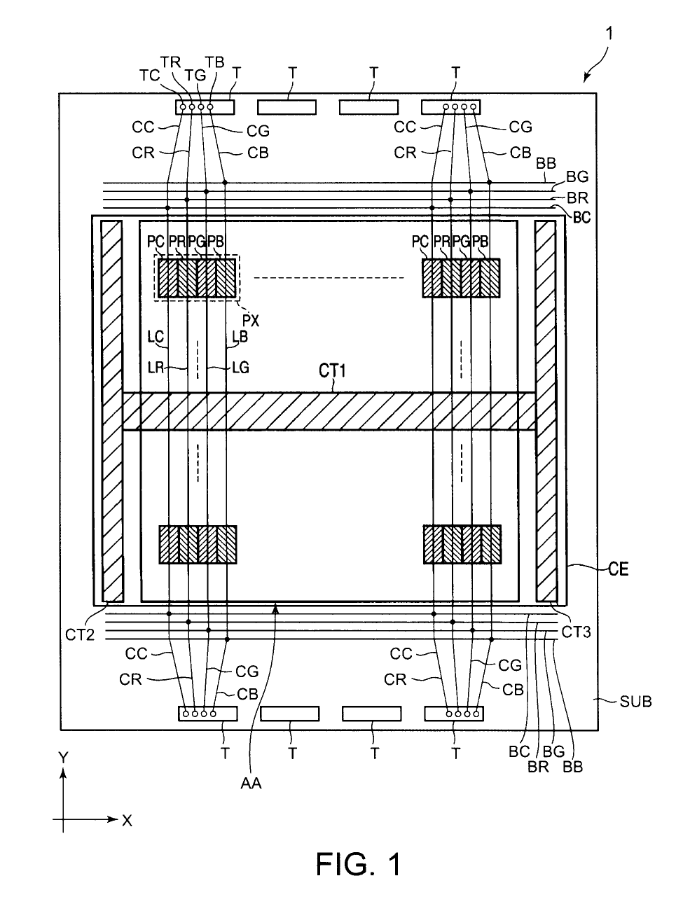

FIG. 1 is a plan view schematically showing a structure of an organic EL lighting apparatus according to an embodiment. The organic EL lighting apparatus includes a panel 1 having a light transmitting insulating substrate SUB in a substantially rectangular shape, such as a glass substrate, etc. The panel 1 includes a plurality of pixels PX arranged in the shape of a matrix in an active area AA of approximately rectangular shape. In the example shown in the figure, each of the pixels PX is constituted by a red pixel PR which emits red light, a green pixel PG which emits green light, a blue pixel PB which emits blue light, and a dot PC for contacting with a cathode electrode.

The red pixel PR, the green pixel PG, the blue pixel PB, and the dot PC for contacting with the cathode electrode are arranged in a line along a direction (a second direction X) in the active area AA. Moreover, the red pixel PR, the green pixel PG, and the blue pixel PB are respectively constituted by organic EL elements, and correspond to light emitting pixels which emit light by supplying a current, to be mention later. In addition, the dot PC for contacting with the cathode electrode is a pixel which does not emit light.

In the active area AA, a red pixel line LR electrically connected with the red pixel PR, a green pixel line LG electrically connected with the green pixel PG, a blue pixel line LB electrically connected with the blue pixel PB, and a cathode line LC electrically connected with the dot PC for contacting with cathode electrode are formed. The red pixel line LR, the green pixel line LG, the blue pixel line LB, and the cathode line LC extend each other in substantially parallel along a Y direction (first direction) which intersects perpendicularly with the X direction.

Moreover, the panel 1 is equipped with a plurality of external power supply input terminals T in the outside of the active area AA. The plurality of external power supply input terminals T is located in a line along the direction X. In the illustrated example, the plurality of external power supply input terminals T with a substantially same pattern is respectively formed in an upper side and a lower side in the figure which face through the active area AA. Various signal sources, such as a flexible wiring substrate (for example, flexible printed circuit) and a driver IC chip for supplying an electric power and various control signals required to drive each pixel PX in the active area AA, are mounted on the external power supply input terminals T.

Each of the external power supply input terminals T has a red electric power supply pad TR, a green electric power supply pad TG, a blue electric power supply pad TB, and a negative power supply pad TC. The red electric power supply pad TR, the green electric power supply pad TG, and the blue electric power supply pad TB correspond to positive electric power supply pads.

In the outside of the active area AA, a red bus line BR, a green bus line BG, a blue bus line BB, and a cathode bus line BC are formed further. The red bus line BR, the green bus line BG, the blue bus line BB, and the cathode bus line BC extend each other in substantially parallel along the direction X, for example. In the illustrated example, the red bus line BR, the green bus line BG, the blue bus line BB, and the cathode bus line BC with a substantially same pattern are respectively formed in the upper and lower sides in the figure which face through the active area AA.

The red pixel line LR is drawn to the outside from the active area AA, and is electrically connected with the red bus line BR. All the red pixel lines LR arranged in the active area AA are connected to the red bus line BR. Similarly, each of the green pixel lines LG is drawn to the outside from the active area AA, and is electrically connected with the green bus line BG. Each of the blue pixel lines LB is drawn to the outside from the active area AA, and is electrically connected with the blue bus line BB. Each of the cathode lines LC is drawn to the outside from the active area AA, and is electrically connected with the cathode bus line BC.

The red bus line BR communalizes the plurality of red electric power supply pads TR, and is electrically connected with each of the red electric power supply pads TR through a red connecting line CR. Similarly, the green bus line BG is electrically connected with the green electric power supply pads TG through a green connecting line CG. The blue bus line BB is electrically connected with each of the blue electric power supply pads TB through a blue connecting line CB. The cathode bus line BC is electrically connected with each of the negative electric power supply pads TC through a cathode connecting line CC.

The first cathode electrode contact CT1 which extends along the direction X is formed in a substantially central portion of the active area AA. The first cathode electrode contact CT1 crosses the active area AA so as to divide the active area AA into substantially two portions. For example, it is possible to constitute the first cathode electrode contact CT1 as an aggregation of the dots PC for the cathode contact. The first cathode electrode contact CT1 is electrically connected with a second cathode electrode contact CT2 and a third cathode electrode contact CT3 which extend along the direction Y in the outside of the active area AA. That is, the second cathode electrode contact CT2 counters the third cathode electrode contact CT3 through the active area AA. The first cathode electrode contact CT1, the second cathode electrode contact CT2, and the third cathode electrode contact CT3 are electrically connected with the negative electric power supply pad TC through the cathode bus line BC.

A cathode electrode CE extends to a substantially whole active area AA and is in contact with the first cathode electrode contact CT1. Furthermore, the cathode electrode CE extends to the outside of the active area AA, and is also in contact with the second cathode electrode contact CT2 and third cathode electrode contact CT3. In addition, in the active area AA, the cathode electrode CE is in contact with the dot PC for the cathode contact arranged in each pixel PX.

According to such structure, a positive electric power supplied to the red electric power supply pad TR is also supplied to each of the red pixels PR connected to the red pixel line LR through the red connecting line CR and the red bus line BR. Similarly, the positive electric power supplied to the green electric power supply pad TG is also supplied to each of the green pixels PG connected to the green pixel line LG through the green connecting line CG and the green bus line BG. The positive electric power supplied to the blue electric power supply pad TB is also supplied to each of the blue pixels PB connected to the blue pixel line LB through the blue connecting line CB and the blue bus line BB.

On the other hand, a negative electric power supplied to the negative electric power supply pad TC is also supplied to each of the first to third cathode contacts CT1 to CT3 while the negative electric power is supplied to each of the dots PC for the cathode contact connected to the cathode line LC through the cathode connecting line CC and the cathode bus line BC. The cathode electric power supplied to the dot PC for cathode contact and the first to third cathode electrode contacts CT1 to CT3 is supplied to the cathode electrode CE.

In addition, the various lines formed in the panel 1, such as the red pixel line LR, the green pixel line LG, the blue pixel line LB, the cathode line LC, the red bus line BR, the green bus line BG, the blue bus line BB, and the cathode bus line BC, are formed using two or more line layers through an insulating layer therebetween.

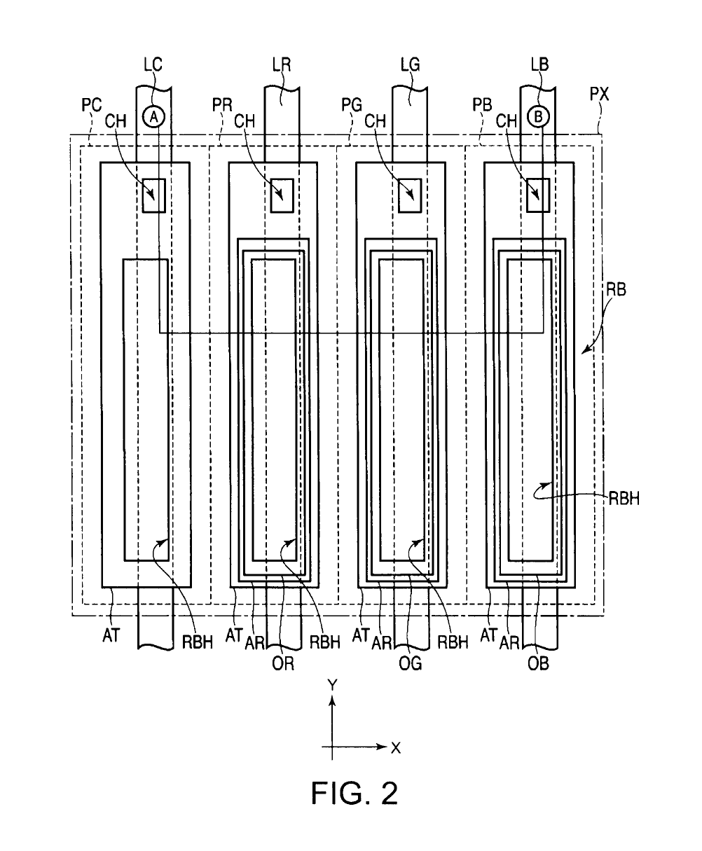

FIG. 2 is a top surface view showing the structure of the pixel PX of the panel 1 shown in FIG. 1. The pixel PX is equipped with the dot PC for the cathode contact, the red pixel PR, the green pixel PG, and the blue pixel PB arranged in a line in the direction X. The red pixel PR, the green pixel PG, and the blue pixel PB are formed with the approximately same structures, and are equipped with a light transmitting electrode AT and a reflective electrode AR which serve as an anode electrode, respectively. The dot PC for the cathode contact also includes the light transmitting electrode AT.

The light transmitting electrode AT and the reflective electrode AR are surrounded with a rib RB. In the illustrated example, an area RBH, i.e., the opening of the rib RB is substantially the same for each of the red pixel PR, the green pixel PG, and the blue pixel PB.

Therefore, it is possible to form the light emitting layer using a same mask at the time of manufacturing, and thereby to result in a suppress of a manufacturing cost.

The light transmitting electrode AT is formed of a light transmissive electric conductive material, such as Indium Tin Oxide (ITO). The reflective electrode AR is formed of the electric conductive material having a light reflective characteristics, such as aluminum (AL). For example, the rib RB is formed of an insulating material, such as resin material.

In the red pixel PR, a red organic material layer OR is arranged in the opening RBH of the rib RB in contact with the reflective electrode AR. The red organic material layer OR contains a light emitting layer which emits red light. Similarly, in the green pixel PG, a green organic material layer OG which contains a light emitting layer for emitting green light is arranged in the opening RBH of the rib RB. Moreover, in the blue pixel PB, a blue organic material layer for emitting blue light is arranged in the opening RBH of the rib RB. The red organic material layer OR, the green organic material layer OG, and the blue organic material layer OB may include a hole injecting layer, a hole transportation layer, an electron injecting layer, and an electron-transporting layer, etc., if needed, in addition to the respective light emitting layers.

In the dot PC for the cathode contact, the light transmitting electrode AT is electrically connected with the cathode line LC through a contact hole CH. Similarly, in the red pixel PR, the light transmitting electrode AT is electrically connected with the red pixel line LR through the contact hole CH. In the green pixel PG, the light transmitting electrode AT is electrically connected with the green pixel line LG through the contact hole CH. In the blue pixel PB, the light transmitting electrode AT is electrically connected with the blue pixel line LB through the contact hole CH.

Although illustration is omitted, the cathode electrode CE is arranged so that the whole pixels PX may be covered with the cathode electrode CE. That is, in the dot PC for the cathode contact, the cathode electrode CE is arranged at the opening RBH of the rib RB, and is in contact with the light transmitting electrode AT electrically connected with the cathode line LC while the cathode electrode CE covers the red organic material layer OR, the green organic material layer OG, and the blue organic material layer OB. In the dot PC for the cathode contact, the light transmitting electrode AT is surrounded with the rib RB, and the area of the opening RBH of the rib RB is substantially the same as the area RBH, i.e., aperture ratio, of the opening of the rib RB in each of the red pixel PR, the green pixel PG, and the blue pixel PB. For this reason, in the dot PC for the cathode contact, the contact of the light transmitting electrode AT with the cathode electrode CE is attained covering a comparatively large area.

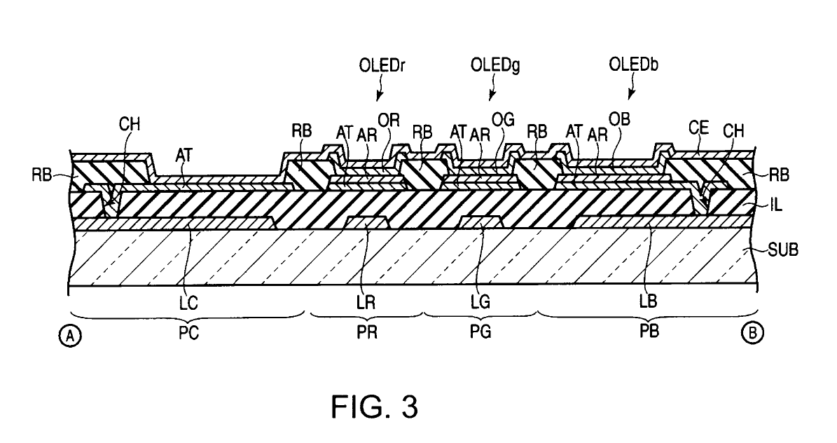

FIG. 3 is a cross-sectional view showing an example of a structure of the pixel taken along line A-B shown in FIG. 2. On the insulating substrate SUB, the cathode line LC, the red pixel line LR, the green pixel line LG, and the blue pixel line LB are formed, respectively. The cathode line LC, the red pixel line LR, the green pixel line LG, and the blue pixel line LB are covered with an insulating film IL. As illustrated, contact holes CH for the cathode line LC, the red pixel line LR, the green pixel line LG and the blue pixel line LB are respectively formed in the insulating film IL.

The transmitting electrode AT is formed on the insulating film IL. The transmitting electrode AT extends up to the contact hole CH. As illustrated, in the dot PC for the cathode contact, the transmitting electrode AT extending to the contact hole CH is electrically connected with the cathode line LC. Also in the blue pixel PB, the transmitting electrode AT extending to the contact hole CH is electrically connected with the blue pixel line LB.

A reflective electrode AR is formed on the respective transmitting electrodes (second transmitting electrode) AT of the red pixel PR, the green pixel PG, and the blue pixel PB. The reflective electrodes AR are respectively surrounded with the rib RB. In addition, in the illustrated example, the reflective electrode AR is not formed on the transmitting electrode (first transmitting electrode) AT of the dot PC for the cathode contact. The cathode electrode CE is arranged on the reflective electrodes AR of the red pixel PR, the green pixel PG, and the blue pixel PB, and is in contact with the transmitting electrode AT of the dot PC for the cathode contact.

In the red pixel PR, the red organic material layer OR is arranged between the reflective electrode AR and the cathode electrode CE, and an organic EL device OLEDr which emits red light is constituted. Similarly, in the green pixel element PG, the green organic material layer OG is arranged between the reflective electrode AR and the cathode electrode CE, and an organic EL device OLEDg which emits green light is constituted. In the blue pixel PB, a blue organic material layer is arranged between the reflective electrode AR and the cathode electrode CE, and an organic EL device OLEDb which emits blue light is constituted. That is, the cathode electrode CE is arranged on the red organic material layer OR, the green organic material layer OG, and the blue organic material layer OB. Moreover, the cathode electrode CE is in contact with the transmitting electrode AT of the dot PC for the cathode contact.

In the panel 1 of such structure, at least the light emitting layer is distinguished by different color with using such technique as a mask vapor deposition method, for each of the red organic material layer OR of the red pixel PR, the green organic material layer OG of the green pixel element PG, and the blue organic material layer OB of the blue pixel PB. A white balance of the pixel PX is adjusted with the positive electric power supplied to each of the red pixel PR, the green pixel PG, and the blue pixel PB.

By the way, in the organic EL equipment, the organic EL display generally uses a line sequential scan system, and the maximum current value turns into a current value only for one row of the active area AA. The negative electric power supply to the cathode electrode CE is performed from a cathode contact provided in the outside of the active area AA. However, the organic EL lighting apparatus is operated by a field sequential system, and the maximum current value turns into a current value of all the pixel PXs. Thus, since the current flows into all the pixels PX all at once, the current load of the cathode electrode CE becomes large, and causes lower luminance. The pixels arranged apart from the cathode contact are in the tendency for luminosity to fall, and the phenomenon in which the luminosity falls in the central portion of the active area AA, i.e., a luminosity unevenness at the central portion, frequently occurs as compared with a peripheral portion.

According to the above-mentioned embodiment, the pixel PX of the active area AA is equipped not only with the light emitting pixel but with the dot PC for the cathode contact. For this reason, the current load of the cathode electrode CE can be reduced. Therefore, while being able to control the variation in each luminosity of the light emitting pixels in the whole active area AA, the generation of an uneven coloring is controlled, and it becomes possible to offer the organic EL lighting apparatus which can emit light with a uniform luminosity.

In addition, it is not necessary to provide the dot PC for the cathode contact in each pixel PX. For example, it is possible to decide what every pixel the dot PC for cathode contact is arranged by estimating the cathode current. For example, the dot PC for cathode contact can be arranged at one rate to several pixels depending on the estimation.

Moreover, according to this embodiment, the active area AA includes the first cathode electrode contact CT1 which crosses a substantially central portion of the active area AA. Thereby, the current load of the cathode electrode CE in the central portion of the active area AA can be reduced. Therefore, it becomes possible to offer the organic EL lighting apparatus which can emit light with a uniform luminosity. In addition, while both of the dot PC for the cathode contact and the first cathode electrode contact CT1 are provided in the above-mentioned example, even if either one of the dot PC and the first cathode electrode contact CT1 is provided, the effect of reducing the current load of the cathode electrode CE is achieved.

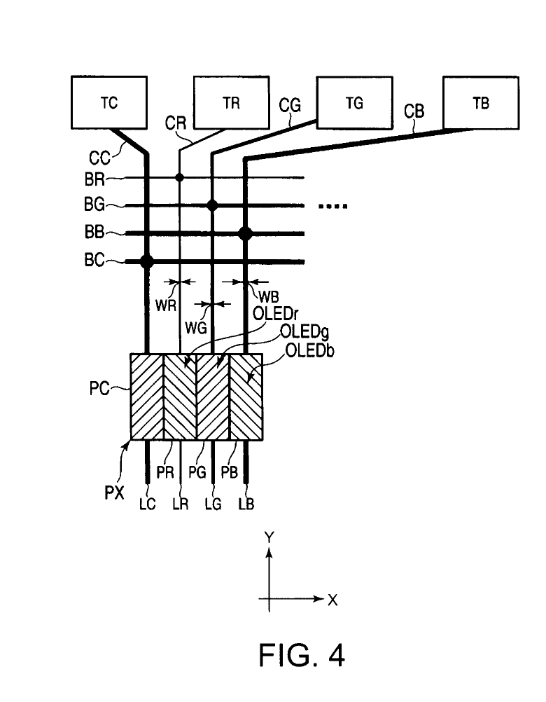

FIG. 4 is a figure for explaining a technique for achieving a uniform characteristics of each light emitting pixel. To the red pixel PR which is the red light emitting pixel, the positive electric power is supplied from the red electric power supply pad TR through the red connecting line CR, the red bus line BR and the red pixel line LR. Similarly, to the green pixel PG which is the green light emitting pixel, the positive electric power is supplied from the green electric power supply pad TG through the green connecting line CG, the green bus line BG and the green pixel line LG. Similarly, to the blue pixel PB which is the blue light emitting pixel, the positive electric power is supplied from the blue electric power supply pad TB through the blue connecting line CB, the blue bus line BB and the blue pixel line LB.

The variation in each device characteristic of the organic EL device OLEDr of the red pixel PR, the organic EL device OLEDg of the green pixel PG, and the organic EL device OLEDb of the blue pixel PB is adjusted by a line resistance of the bus line and the pixel line connected to each organic EL device. The line resistance is a value based on the line width of the bus line and the pixel line, and the line length of the bus line and the pixel line. Namely, the line resistance becomes small in an inverse proportion to the line width, and in a proportion to the line length

In this embodiment, the line resistance of the respective pixel lines and the bus lines are adjusted so that a voltage drop in each light emitting pixel may be equalized by estimating each reference voltage drop of the red pixel PR, the green pixel PG, and the blue pixel PB. Otherwise, the line resistances of each pixel line and bus line are adjusted so that the element characteristic of each light emitting pixel may be equalized.

Hereinafter, a more practical calculation method of a voltage drop is shown. Here, a case where a plurality of same color pixels is connected to a pixel line is explained. That is, in the active area AA, the pixels arranged along one row are constituted by color pixels of the same color, and the number of the color pixels connected to each pixel line is the same for any colors.

The voltage drop per row is expressed as a following formula;

Current value per row×Line resistance (pixel line+bus line)=the voltage drop per row.

The voltage drop in the red pixels PR connected to one red pixel line LR, the voltage drop in the green pixel PG connected to one green pixel line LG, and the voltage drop in the blue pixel PB connected to one blue pixel line LB are calculated by the above-mentioned formula, respectively.

For example, since a drive current of the blue pixel PB is higher than other color pixels, the case where the element characteristic of each light emitting pixel is equalized with reference to the voltage drop of the blue pixel PB is explained. First, the reference voltage drop is estimated in the blue pixel PB by the above-mentioned formula. Then, the line resistance is adjusted so that the estimated voltage drop in the blue pixel PB, for example, becomes substantially the same as the voltage drop in each of the red pixel PR and the green picture element PG. In adjusting the line resistance, when it is difficult to change the line length L, it is possible to adjust the line resistance by changing the line width W.

In the illustrated example, the line width WB of the blue pixel line LB is set to be larger than any of the line width WR of the red pixel line LR and the line width WG of the green pixel line LG for adjusting each line resistance. Similarly, the line width of the blue bus line BB is set to be larger than any of the line width of the red bus line BR and the line width of the green bus line BG. Thereby, it becomes possible to set the voltage drop in each light emitting pixel to substantially the same value, or it becomes possible to equalize the element characteristic of each light emitting pixel. Therefore, it becomes possible to offer the organic EL lighting apparatus which can emit light with a uniform luminosity.

In addition, as another example of adjusting each line resistance, the line length may be changed while the line width is set to the same. Further, both of the line width and the line length may be changed.

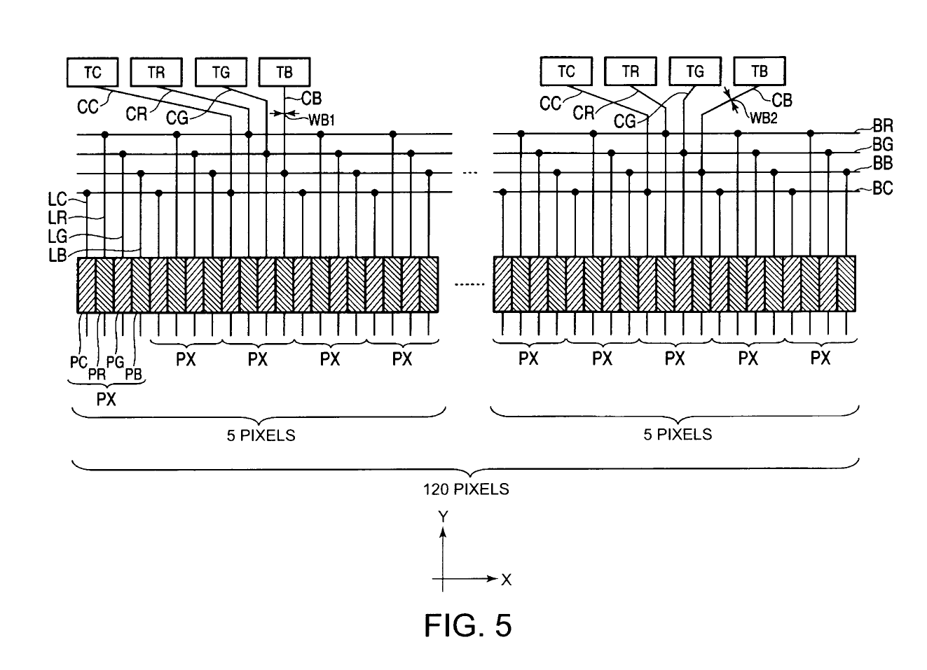

FIG. 5 is a figure for explaining another technique for equalizing the characteristics of each light emitting pixel. In this embodiment, a plurality of electric supply pads is arranged so that the load (bus line+pixel line) per power supply pad becomes substantially equal.

As an example, a case is explained, in which 120 pixels each including the red pixel PR, the green pixel PG, the blue pixel PB, and the pixel PX that consists of the dot PC for the cathode contact are arranged in a line in the X direction. In case the electric power supply pad is formed of 24 pads, i.e., six electric power supply pads for each of the negative electric power supply pad TC, the red electric power supply pad TR, the green electric power supply pad TG, and the blue electric power supply pad TB are formed, the respective power supply pads are connected to the bus lines with regular intervals. Each power supply pad is connected to 5 pixel lines through a bus line because (120 pixels)/(24 power supply pads)=5 pixels/power supply pad.

That is, while 5 red pixel lines LR are electrically connected to the first red electric power supply pad TR of the left-hand side in a figure through the red bus line BR, the red pixel lines LR of the same number (i.e., 5 power supply lines) are electrically connected to the second red electric power supply pad TR of the right-hand side in the figure through a red bus line BR. Therefore, the load (bus line+pixel line) per power supply pad is substantially the same. For the green electric power supply pad TG, the blue electric power supply pad TB, and the negative electric power supply pad TC, the load per the power supply pad is substantially the same.

Accordingly, the generation of a luminosity inclination between the power supply pads can be controlled. Therefore, it becomes possible to offer the organic EL lighting apparatus which can emit light with a uniform luminosity.

Moreover, in this embodiment, the connecting lines which connect between each power supply pad and each bus line in the plurality of power supply pads is constituted so that the voltage drop in each of the connecting line may be set to a substantially same value.

As illustrated, when the pitch between the power supply pads differs from the pitch between the pixel lines, the length of the connecting line which connects the power supply pad with the bus line may be different each other. For example, the line length of the first blue connecting line CB which connects the first blue electric power supply pad TB with the blue bus line BB in the left-hand side in the figure is shorter than the line length of the second blue connecting line CB which connects the second blue electric power supply pad TB with the blue bus line BB in the right-hand side in the figure. When the line width of the first blue connecting line CB is the same as the line width of the second blue connecting line CB, the line resistance of the second blue connecting line CB is larger than the line resistance of the first blue connecting line CB. For this reason, the voltage drop in the second blue connecting line CB becomes larger than the voltage drop in the first blue connecting line CB.

Then, the line width WB2 of the second blue connecting line CB is set to be greater than the line width WB1 of the first blue connecting line CB like the example shown in FIG. 4. Thereby, the line resistance of the first blue connecting line CB and the line resistance of the second blue connecting line CB can be set so that the voltage drop in the first blue connecting line CB becomes substantially the same as that of the second blue connecting line CB.

In addition, the same adjustment is also possible for each of the red connecting line CR, the green connecting line CG, and the cathode connecting line CC.

Thereby, the generation of the luminosity inclination between the power supply pads can be controlled. Accordingly, it becomes possible to offer the organic EL lighting apparatus which can emit light with a uniform luminosity.

Furthermore, in the above-mentioned explanation, the power supply voltage supplied from each power supply pad is set to be a total voltage value of the drive voltage of the organic EL device and the voltage drop (pixel line+bus line+between power supply PAD and bus line).

As described-above, according to this embodiment, the organic EL lighting apparatus which can emit light by a uniform luminosity can be offered by arranging the dot PC for the cathode contact and the first cathode electrode contact CT1. Further, the high quality organic EL lighting apparatus is obtained by at least one or combining the above-mentioned adjustment methods, such as the adjustment by the line resistance of the bus line and the pixel line, the equalization of the load (bus line+pixel line) per power supply pad, and the adjustment of the line resistance of the connecting line.

While certain embodiments have been described, these embodiments have been presented by way of example only, and are not intended to limit the scope of the inventions. In practice, the structural and method elements can be modified without departing from the spirit of the invention. Various embodiments can be made by properly combining the structural and method elements disclosed in the embodiments. For example, some structural and method elements may be omitted from all the structural and method elements disclosed in the embodiments. Furthermore, the structural and method elements in different embodiments may properly be combined. The accompanying claims and their equivalents are intended to cover such forms or modifications as would fall with the scope and spirit of the inventions.

What is claimed is:

1. An organic EL lighting apparatus, comprising:
a pixel line and a cathode line extending in substantially parallel each other in an active area;
a light emitting pixel including an anode electrode electrically connected to the pixel line, a cathode electrode arranged on the anode electrode and a light emitting organic layer arranged between the anode electrode and the cathode electrode; and
a dot arranged adjacent to the light emitting pixel for a contact of the cathode line with the cathode electrode.

2. An organic EL lighting apparatus, comprising:
an insulating substrate;
a pixel line and a cathode line arranged on the insulating substrate;
an insulating layer formed on the pixel line and the cathode line;
a first light transmitting electrode arranged on the insulating substrate and electrically connected with the cathode line through a first contact hole;
a second light transmitting electrode arranged on the insulating substrate and electrically connected with the pixel line through a second contact hole;
a reflective electrode arranged on the second light transmitting electrode;
a light emitting organic layer formed on the reflective layer; and
a cathode electrode arranged on the light emitting organic layer and contacting with the first light transmitting electrode.

3. The organic EL lighting apparatus according to claim 2, further comprising a rib, wherein the rib includes a first opening surrounding the first light transmitting electrode and a second opening surrounding the second light transmitting electrode and the reflective electrode, and the area of the first opening is substantially the same as that of the second opening.

4. An organic EL lighting apparatus, comprising:
a positive electric power supply pad and a negative electric power supply pad;
a plurality of pixel lines connected with the positive electric power supply pad and extending in a first direction in an active area;
a first cathode electrode contact electrically connected to the negative electric power supply pad and extending in a second direction orthogonally crossing the first direction in a substantially central portion of the active area; and
a light emitting pixel including an anode electrode electrically connected with the pixel line, a cathode electrode arranged on the anode electrode and contacting with the first cathode electrode contact, and a light emitting organic layer arranged between the anode electrode and the cathode electrode.

5. The organic EL lighting apparatus according to claim 4, further comprising a second cathode electrode contact extending in the first direction in the outside of the active area, wherein the first cathode electrode contact extends to the outside of the active area and contacts with the second cathode electrode contact.

6. The organic EL lighting apparatus according to claim 4, wherein the first cathode electrode contact is constituted by an aggregation of a dot in which the cathode line electrically connected with the negative electric power supply pad and extending in the first direction in the active area contacts with the cathode electrode.

7. An organic EL lighting apparatus, comprising:
a first electric power supply pad and a second electric power supply pad;
a first bus line electrically connected with the first electric power supply pad;
a second bus line electrically connected with the second electric power supply pad;
a first pixel line electrically connected with the first bus line;
a second pixel line electrically connected with the second bus line;
a first light emitting pixel including a first anode electrode connected with the first pixel line, a cathode electrode arranged on the first anode electrode, and a first light emitting organic layer for emitting a first color arranged between the first anode electrode and the cathode electrode; and
a second light emitting pixel including a second anode electrode connected with the second pixel line, a cathode electrode arranged on the second anode electrode and a second light emitting organic layer for emitting a second color arranged between the second anode electrode and the cathode electrode;
wherein the respective line resistances of the first bus line and the first pixel line, and the respective line resistances of the second bus line and the second pixel line are set so that a voltage drop in the first light emitting pixel becomes substantially the same as that of the second light emitting pixel.

8. The organic EL lighting apparatus according to claim 7, wherein the first light emitting pixel is formed of a blue color pixel for emitting blue color, and the second light emitting pixel is formed of a red color pixel for emitting red color or a green pixel for emitting green color, and the line width of the first pixel line is set to be a larger value than that of the second pixel line.

9. The organic EL lighting apparatus according to claim 7, wherein the first light emitting pixel is formed of a blue color pixel for emitting blue color, and the second light emitting pixel is formed of a red color pixel or a green pixel for emitting red color or green color, and the line width of the first bus line is set to be a larger value than that of the second bus line.

10. An organic EL lighting apparatus, comprising:
a first electric power supply pad and a second electric power supply pad;
a first bus line electrically connected with the first electric power supply pad;
a second bus line electrically connected with the second electric power supply pad;
a first pixel line electrically connected with the first bus line;
a second pixel line electrically connected with the second bus line;
a first light emitting pixel including a first anode electrode connected with the first pixel line, and
a second light emitting pixel including a second anode electrode connected with the second pixel line;
wherein a total load of the first bus line and the first pixel line in the first power supply pad is substantially the same as that of the second bus line and the second pixel line in the second power supply pad.

11. The organic EL lighting apparatus according to claim 10, wherein the number of the first pixel lines connected with the first bus line is equal to that of the second pixel lines connected with the second bus line.

12. An organic EL lighting apparatus, comprising:
a first electric power supply pad and a second electric power supply pad;
a first bus line and a second bus line;
a first connecting line for electrically connecting the first electric power supply pad with the first bus line;
a second connecting line for electrically connecting the second electric power supply pad with the second bus line;
a first pixel line electrically connected with the first bus line;
a second pixel line electrically connected with the second bus line;
a first light emitting pixel including a first anode electrode connected with the first pixel line, and
a second light emitting pixel including a second anode electrode connected with the second pixel line;
wherein the respective line resistances of the first connecting line and the second connecting line are set so that a voltage drop of the first connecting line becomes substantially the same as that of the second connecting line.

13. The organic EL lighting apparatus according to claim 12, wherein the line length of the first connecting line is set to be shorter than that of the second connecting line, and the line width of the second connecting line is set to be larger than that of the first connecting line.

14. An organic EL lighting apparatus, comprising:
a first electric power supply pad and a second electric power supply pad;
a first bus line electrically connected with the first electric power supply pad;
a second bus line electrically connected with the second electric power supply pad;
a first pixel line electrically connected with the first bus line;
a second pixel line electrically connected with the second bus line;
a first connecting line for electrically connecting the first electric power supply pad with the first bus line;
a second connecting line for electrically connecting the second electric power supply pad with the second bus line;
a first light emitting pixel including a first anode electrode connected with the first pixel line, a cathode electrode arranged on the first anode electrode, and a first light emitting organic layer for emitting a first color arranged between the first anode electrode and the cathode electrode; and
a second light emitting pixel including a second anode electrode connected with the second pixel line, a cathode electrode arranged on the second anode electrode and a second light emitting organic layer for emitting a second color arranged between the second anode electrode and the cathode electrode;
wherein the respective line resistances of the first bus line and the first pixel line, and the respective line resistances of the second bus line and the second pixel line are set so that a voltage drop in the first light emitting pixel becomes substantially the same as that of the second light emitting pixel, and
wherein the respective line resistances of the first connecting line and the second connecting line are set so that a voltage drop of the first connecting line becomes substantially the same as that of the second connecting line.

15. The organic EL lighting apparatus according to claim 14, wherein the first light emitting pixel is formed of a blue color pixel for emitting blue color, and the second light emitting pixel is formed of a red color pixel for emitting red color or a green pixel for emitting green color, and the line width of the first pixel line is set to be a larger value than that of the second pixel line.

16. The organic EL lighting apparatus according to claim 14, wherein the first light emitting pixel is formed of a blue color pixel for emitting blue color, and the second light emitting pixel is formed of a red color pixel or a green pixel for emitting red color or green color, and the line width of the first bus line is set to be a larger value than that of the second bus line.

17. The organic EL lighting apparatus according to claim 14, wherein the number of the first pixel lines connected with the first bus line is equal to that of the second pixel lines connected with the second bus line.

18. The organic EL lighting apparatus according to claim 14, wherein the line length of the first connecting line is set to be shorter than that of the second connecting line, and the line width of the second connecting line is set to be larger than that of the first connecting line.
